(19) United States
(12) Patent Application Publication
(10) Pub. No.: US 2008/0136755 A1
(43) Pub. Date: Jun. 12, 2008

(54) DISPLAY APPARATUS AND METHOD FOR CONTROLLING CONTRAST THEREOF

(75) Inventor: Shu-Wen Chuang, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/673,151

(22) Filed: Feb. 9, 2007

(30) Foreign Application Priority Data
Dec. 11, 2006 (TW) 95146210

(51) Int. Cl. G09G 3/36

(52) U.S. Cl. 345/87

(57) ABSTRACT

A method for controlling the contrast of a display apparatus is provided. The method includes following steps. The invention compiles the brightness distribution of the image signal and adjusts at least the contrast ratio and/or the brightness in the on-screen display (OSD) configuration of the display apparatus according to the brightness distribution of the image signal. Thus, the contrast of the display apparatus is adjusted.

### CROSS-REFERENCE TO RELATED APPLICATION

This application claims the priority benefit of Taiwan application serial no. 95146210, filed Dec. 11, 2006. All disclosure of the Taiwan application is incorporated herein by reference.

### BACKGROUND OF THE INVENTION

1. Field of the Invention

The present invention generally relates to a display apparatus, and more particularly, to a display apparatus that automatically adjusts the contrast of the display.

2. Description of Related Art

At present, the increasing consumer demand for computer, communication and consumer electronics product has ushered in an era termed as the 3C era. Conceivably, the market is filled with all kinds of information appliances such as mobile phones, personal digital assistants (PDA), global positioning systems (GPS), digital cameras and display apparatuses. In most information appliances, flat panel displays are used as the primary user interface.

In the traditional display appliances, the primary user interface used is cathode ray tube. With the recent advancement in the semiconductor fabrication techniques, both liquid crystal display panel and plasma display panel are favored over the traditional cathode ray tube because they are lighter, thinner, more compact and consume less power.

The technical specifications for the above-mentioned display panels include viewing angle, weight, power consumption, response speed, resolution and contrast ratio. Herein, contrast refers to the relative brightness ratio of the brightest part to the darkest part of an image. When the difference in brightness becomes larger, the contrast is larger. Conversely, when the difference in brightness becomes smaller the contrast is smaller. A good contrast ratio facilitates the display of vivid and rich colors, and supports the display for all levels of colors.

However, in today's display apparatuses, the parameters such as contrast are still configured manually through manipulating on-screen display (OSD) interface and basic input/output system (BIOS). No display apparatuses available in today's market are able to instantly detect image signals to adjust the contrast of the display.

### SUMMARY OF THE INVENTION

The present invention provides a display apparatus that can instantly detect image signals and then automatically adjust the contrast ratio and/or the brightness.

The present invention provides a method for controlling the contrast of the display apparatus that can instantly detect image signals and then automatically adjust the contrast ratio and/or the brightness of the display.

To resolve the above-mentioned problems, the present invention provides a display apparatus, including a display panel, a driving module and a control module. Herein, the driving module is used to drive the display panel and the control module is used to control the driving module according to the image signal and the configuration of the on-screen display (OSD) to display images on the image display. Further, the control module compiles the brightness distribution of the image signals and adjusts at least the contrast ratio and/or the brightness in the OSD configuration based on the brightness distribution of the image signal.

According to an embodiment of the present invention, the gray-level range for the image signal of the display apparatus includes a first sub-range, a second sub-range and a third sub-range. Further, the image signals include a first ratio value, a second ratio value and a third ratio value corresponding to the respective brightness distribution in the first sub-range, the second sub-range and the third sub-range.

According to an embodiment of the present invention, the control module of the display apparatus compares the magnitudes of the first ratio value, the second ratio value and the third ratio value. When the first ratio value is greater than the second ratio value and the third ratio value, the control module adjusts the contrast ratio in the OSD configuration. When the third ratio value is greater than the first ratio value and the second ratio value, the control module adjusts the brightness in the OSD configuration. When the second ratio value is greater than the first ratio value and the third ratio value, the control module restores the contrast ratio and the brightness to the original setting in the OSD configuration.

From another point of view, the present invention provides a method for controlling the contrast ratio of the display apparatus. The method includes calculating the brightness distribution of the image signals and adjusting at least the contrast ratio and/or the brightness in the OSD configuration of the display apparatus according to the brightness distribution of the image signals.

According to an embodiment of the present invention, the gray-level range for the image signal of the display apparatus includes a first sub-range, a second sub-range and a third sub-range. Further, the image signals include a first ratio value, a second ratio value and a third ratio value corresponding to the respective brightness distribution in the first sub-range, the second sub-range and the third sub-range.

According to an embodiment of the present invention, the control module of the display apparatus compares the magnitudes of the first ratio value, the second ratio value and the third ratio value. When the first ratio value is greater than the second ratio value and the third ratio value, the contrast ratio in the OSD configuration is adjusted. When the third ratio value is greater than the first ratio value and the second ratio value, the brightness in the OSD configuration is adjusted. When the second ratio value is greater than the first ratio value and the third ratio value, the contrast ratio and the brightness are restored to the original setting in the OSD configuration.

When the display apparatus of the present invention receives an image signal, it will compile the brightness distribution of the image signal. Next, the OSD configuration of the display apparatus is adjusted according to the brightness distribution of the image signal to allow the user to see a display image in distinctive colors.

In order to make the aforementioned and other objects, features and advantages of the present invention more comprehensible, preferred embodiments accompanied with figures are described in detail below.

### BRIEF DESCRIPTION OF THE DRAWINGS

FIG. 1 is a block diagram schematically illustrating the circuit of the display apparatus according to a preferred embodiment of the present invention.

FIG. 2 is a graph schematically illustrating the brightness distribution of the present invention.

FIG. 3 is another graph schematically illustrating the brightness distribution of the present invention.

FIG. 4 illustrates the steps for controlling the contrast ratio of the display apparatus according to a preferred embodiment of the present invention.

### DESCRIPTION OF EMBODIMENTS

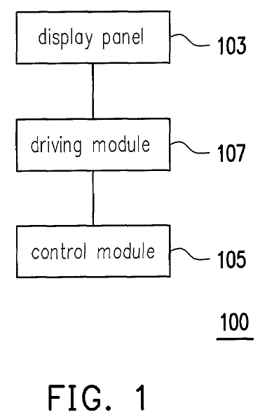

FIG. 1 is a block diagram schematically illustrating the circuit of the display apparatus according to a preferred embodiment of the present invention. In FIG. 1, according to the present embodiment, a display apparatus 100 includes a display panel 103, a driving module 107 and a control module 105. Herein, the driving module 107 is used to drive the display panel 103, and the control module 105 is used to control the driving module 107 according the image signal and the on-screen display (OSD) setting mechanism to display images on the display panel 103. The image signal can be an image signal adjusted by the scaler integrated circuit or an image signal unadjusted by the scaler integrated circuit. In other words, according to the present embodiment, any signal carrying image information in the display apparatus is termed as an “image signal” that can be used by the control module 105.

The OSD has been widely used in a variety of display apparatuses to provide a control interface for the user to adjust all kinds of display parameters such as the contrast ratio, brightness, and trapezoid correction. Those of ordinary skill in the art can implement the OSD by any means. Generally, the OSD includes memory function such as a memory structure that can be used to record all the display parameters selected by the user.

In the present embodiment, the display panel 103 can be a liquid crystal display panel. It is well known that the display panel has a scan line and a data line that is arranged in parallel to the scan line. Also, there is a pixel unit disposed at every junction formed by one scan line and one data line. To avoid confusing the spirit of the present invention with that of the related art, the present embodiment has not disclosed the aforementioned feature. Nevertheless, those skilled in the art would know that there are other devices included in a display panel. Hence, a detailed description thereof is omitted.

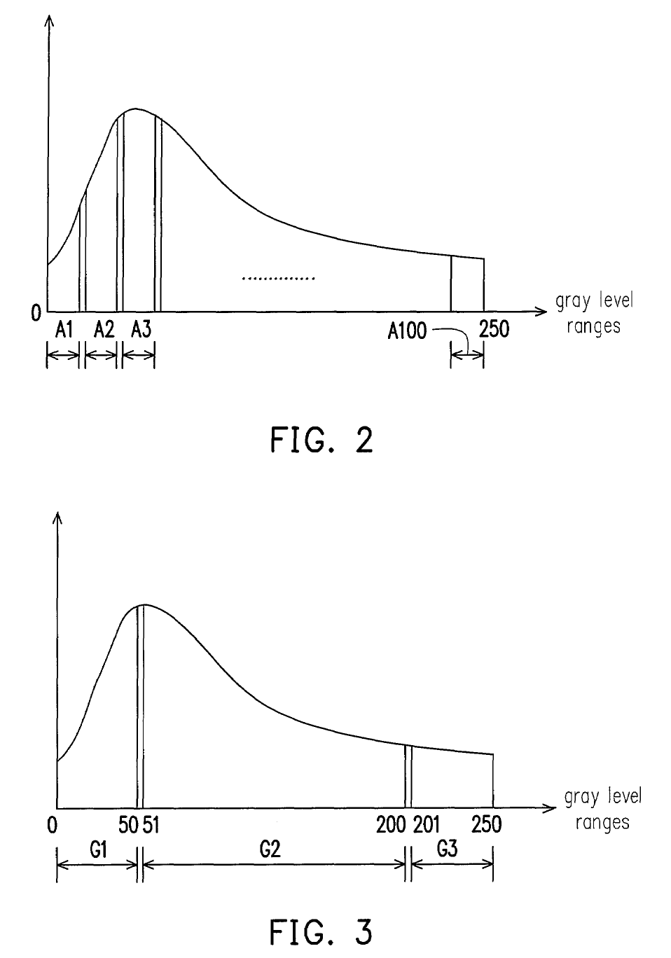

FIG. 2 is a graph schematically illustrating the brightness distribution of the present invention. In FIG. 2, according to the present embodiment, when a display apparatus 100 receives an image signal, it will compile the brightness distribution of the image signal using a program, a circuit or other means. According to the present embodiment, the gray-level range begins from the 0^{th} level to the 250^{th} level, and every 25 levels is considered as one unit. Therefore, there is a total of 100 areas, A1˜A100. Next, the display apparatus will respectively calculate the ratio of the total number of pixels in a specific area to the brightness distribution of all the pixels in the specific area within a frame of an image signal. For instance, if the total number of pixels in a frame of the image signal is 600*800=480000 and the number of pixels in the frame belonging to the brightness of the 0^{th} level to the 25^{th} level is 500. Then, the brightness distribution is approximately 0.1%. It should be noted that, according to the present embodiment, the gray-level range for the brightness distribution of any image signal is between the 0^{th} level and the 250^{th} level.

Nonetheless, those skilled in the art would know that the gray-level range of the present embodiment is not limited to between the 0^{th} level and the 250^{th} level. Specifically, the number of levels for the gray-level range can be varied according to the design of the display apparatus. Further, according to the present embodiment, the brightness distribution is not limited to considering 50 levels as one unit and dividing the brightness distribution into 50 areas. Those skilled in the art can increase or decrease the number of areas on the brightness distribution as desired.

FIG. 3 is another graph schematically illustrating the brightness distribution of the present invention. In FIG. 3, according to the present embodiment, to simplify the illustration, the gray-level range is divided into three ranges, namely a first sub-range G1, a second sub-range G2, and a third sub-range G3. Herein, the first sub-range G1 includes the 0^{th} level to the 50^{th} level, the second sub-range G2 includes the 51^{st} level to the 200^{th} level, and the third sub-range G3 includes the 201^{st} level to the 250^{th} level.

Please refer to FIG. 1 and FIG. 3. If the brightness distribution ratio for the first sub-range G1 is 60%, the brightness distribution ratio for the second sub-range G2 is 30%, and the brightness distribution ratio for the third sub-range is 10%, it means that the image of the image signal is somewhat dark. Therefore, the control module 105 adjusts the brightness setting in the OSD configuration to increase the contrast of the display image. In the present embodiment, the brightness in the OSD configuration is temporarily lowered by a small amount through lowering the image brightness of the display panel appropriately to achieve a better visual contrast for the somewhat dark image.

If the brightness distribution ratio for the first sub-range G1 is 10%, the brightness distribution ratio for the second sub-range G2 is 30%, and the brightness distribution ratio for the third sub-range is 60%, it means the image of the image signal is somewhat bright. Therefore, the control module 105 adjusts the contrast ratio in the OSD configuration to increase the contrast of the display image. In the present embodiment, the contrast ratio in the OSD configuration is temporarily lowered by a small amount through lowering the image contrast of the display panel appropriately to achieve a better visual contrast for the somewhat bright image.

If the brightness distribution ratio for the first sub-range G1 is 20%, the brightness distribution ratio for the second sub-range G2 is 60%, and the brightness distribution ratio for the third sub-range is 20%, it means the image of the image signal is not too bright and not too dark. Hence, the control module 105 restores the contrast ratio and the brightness to the original setting in the OSD configuration.

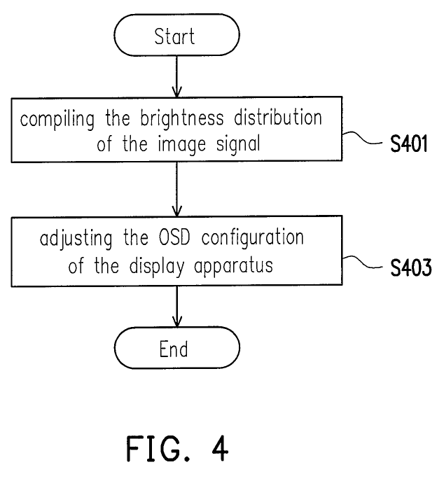

FIG. 4 illustrates the steps for controlling the contrast ratio of the display apparatus according to a preferred embodiment of the present invention. In FIG. 4, the method for controlling the contrast ratio of the display apparatus according to the present embodiment includes the following steps. When the display apparatus receives an image signal, it will first compile the brightness distribution of the image signal (step S401). Further, the gray-level range of the image signal includes a first sub-range, a second sub-range and a third sub-range. According to the present embodiment, the first sub-range includes the 0^{th} level to the 50^{th} level, the second sub-range includes the 51^{st} level to the 200^{th} level, and the third sub-range includes the 201^{st} level to the 250^{th} level.

Herein, a first ratio value corresponds to the brightness distribution in the first sub-range, a second ratio value corresponds to the brightness distribution of the second sub-range, and a third ratio value corresponds to the brightness distribution of the third sub-range. Next, the display apparatus adjusts at least the contrast ratio and/or the brightness in the OSD configuration according to the brightness distribution of each sub-range (step S403).

When the first ratio value is greater than the second ratio value and the third ratio value, it means that the image of the image signal is somewhat dark. Hence, the contrast ratio in the OSD configuration is adjusted to increase the contrast of the display image.

When the third ratio value is greater than the first ratio value and the second ratio value, it means that the image of the image signal is somewhat bright. Hence, the brightness in the OSD configuration is adjusted to increase the contrast of the display image.

When the second ratio value is greater than the first ratio value and the third ratio value, it means that the image of the image signal is not too bright and not too dark. Hence, the contrast ratio and the brightness is restored to the original setting in the OSD configuration.

Accordingly, when the display apparatus of the present invention receives an image signal, it will compile the brightness distribution of the image signal. Next, the OSD configuration of the display apparatus is adjusted according to the brightness distribution of the image signal to allow the user to see a display image in vivid colors.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A display apparatus, comprising:
a display panel;
a driving module that is used to drive the display panel; and
a control module that is used to control the driving module according to the image signal and the configuration of the on-screen display (OSD) to display images on the image display, wherein the control module compiles the brightness distribution of the image signals and adjusts at least the contrast ratio and/or the brightness in the on-screen display (OSD) configuration based on the brightness distribution of the image signal.

2. The display apparatus of claim 1, wherein the gray-level range for the image signal of the display apparatus comprises a first sub-range, a second sub-range and a third sub-range and the image signal comprises a first ratio value, a second ratio value and a third ratio value corresponding to the respective brightness distribution of the first sub-range, the second sub-range and the third sub-range.

3. The display apparatus of claim 2, wherein the first sub-range is between the 0^{th} level and the 50^{th} level, the second sub-range is between the 51^{st} level and the 200^{th} level, and the third sub-range is between the 201^{st} level and the 250^{th} level.

4. The display apparatus of claim 2, wherein the control module compares the magnitudes of the first ratio value, the second ratio value and the third ratio value;
when the first ratio value is greater than the second ratio value and the third ratio value, the control module adjusts the contrast ratio in the OSD configuration;
when the third ratio value is greater than the first ratio value and the second ratio value, the control module adjusts the brightness in the OSD configuration; and
when the second ratio value is greater than the first ratio value and the third ratio value, the control module restores the contrast ratio and the brightness to the original setting in the OSD configuration.

5. The display apparatus of claim 1, wherein the display panel is a liquid crystal display panel.

6. A method for controlling the contrast of a display apparatus, comprising the steps of:
calculating the brightness distribution of an image signal; and
adjusting at least the contrast ratio and/or the brightness in the OSD configuration based on the brightness distribution of the image signal.

7. The method of claim 6, wherein the gray-level range for the image signal comprises a first sub-range, a second sub-range and a third sub-range and the image signal comprises a first ratio value, a second ratio value and a third ratio value corresponding to the respective brightness distribution of the first sub-range, the second sub-range and the third sub-range.

8. The method of claim 7, wherein the first sub-range is between the 0^{th} level and the 50^{th} level, the second sub-range is between the 51^{st} level and the 200^{th} level, and the third sub-range is between the 201^{st} level and the 250^{th} level.

9. The method of claim 7, further comprising:
comparing the magnitudes of the first ratio value, the second ratio value and the third ratio value,
when the first ratio value is greater than the second ratio value and the third ratio value, the contrast ratio in the OSD configuration is adjusted;
when the third ratio value is greater than the first ratio value and the second ratio value, the brightness in the OSD configuration is adjusted; and
when the second ratio value is greater than the first ratio value and the third ratio value, the contrast ratio and the brightness are restored to the original setting in the OSD configuration.
